(19) United States
(12) Patent Application Publication
(10) Pub. No.: US 2008/0095881 A1
(43) Pub. Date: Apr. 24, 2008

(54) FIBER AND NATURAL CHELATOR COMPOSITION SUITABLE FOR EFFECTIVE DETOXIFICATION

(75) Inventor: Leonid Ber, West Palm Beach, FL (US)

Correspondence Address: EDWARDS ANGELL PALMER & DODGE LLP, P.O. BOX 55874, BOSTON, MA, 02205, US

(73) Assignee: Garden of Life, Inc.

(21) Appl. No.: 11/864,055

(22) Filed: Sep. 28, 2007

Related U.S. Application Data
(60) Provisional application No. 60/848,298, filed on Sep. 29, 2006.

(51) Int. Cl. A23L 1/29

(52) U.S. Cl. 426/2; 426/71

(57) ABSTRACT

The present invention relates to a composition of natural dietary fibers for use as a component of a nutritional food composition. More particularly, the present invention relates to a composition of non-fermentable dietary fibers and a natural chelator for the more effective detoxification of a subject for prophylactic and therapeutic purposes.

### CROSS-REFERENCE TO RELATED APPLICATIONS

This Application claims the benefit of U.S. Provisional Application No. 60/848,298 filed on Sep. 29, 2006, entitled, FIBER AND NATURAL CHELATOR COMPOSITION SUITABLE FOR EFFECTIVE DETOXIFICATION the disclosure of which is hereby incorporated by reference in its entirety.

### INCORPORATION BY REFERENCE

The foregoing applications, and all documents cited therein or during their prosecution and all documents cited or referenced therein, and all documents cited or referenced herein (“herein cited documents”), and all documents cited or referenced in herein cited documents, together with any manufacturer's instructions, descriptions, product specifications, and product sheets for any products mentioned herein or in any document incorporated by reference herein, are hereby incorporated herein by reference, and may be employed in the practice of the invention.

### BACKGROUND OF THE INVENTION

The present invention relates to a composition of natural dietary fibers for use as a component of a nutritional food composition. More particularly, the present invention relates to a composition of non-fermentable dietary fibers and a natural chelator for the more effective detoxification of a human subject for prophylactic and therapeutic purposes.

Numerous types of dietary fibers are currently available. Dietary fiber passes through the small intestine undigested by enzymes and acts as a natural detoxifying agent. Dietary fiber is understood to be all of the components of a food that are not broken down by enzymes in the human digestive tract to produce small molecular compounds which are then absorbed into the bloodstream. These components are mostly carbohydrates, celluloses, hemicelluloses, pectin, gums, mucilages, lignin and lignin material varying in different plants according to type and age. Although not a carbohydrate, lignin, a highly branched polymer comprised of phenylpropanoid units found within “woody” plant cell walls, is classified as a dietary fiber because of its close association with the plant polysaccharides and fiber-like physiological effects. Different fibers differ significantly in their chemical composition and physical structure and subsequently their physiological function.

The properties of fibers (or fiber systems) most related to physiological function are sorption and fermentability. Sorption is essentially represented by two mechanisms: absorption and adsorption. Absorption takes place when solids, gases, liquids, or solutes are taken in through pores or interstices of a solid or liquid. Adsorption takes place when solids, gases, liquids, or solutes accumulate on the surface of a solid or liquid. Both mechanisms of sorption are applicable to describe the sorbing effect of fibers in aqueous solutions. Desorption takes place when sorbed substances are removed from the sorbent. Desorption results from degradation of the sorbent resulting in abolition of the sorbing properties.

Fermentability is represented by the systemic degradation of fibers (or fiber systems) by intestinal microbiota through the process of fermentation. Based on their fermentability, dietary fibers can be classified into two groups: (a) fermentable and (b) fermentation-resistant fibers. Fermentability of dietary fibers depends on their chemical structure and composition. Fermented fiber components include beta-glucans, pectins, gums, inulin and various oligosaccharides. Fiber components resistant to fermentation are typically cellulose, hemicellulose, lignin, plant waxes (cutin, suberin), chitin and chitosan. Fermentation of a fiber degrades its sorbent qualities.

Natural chelators, such as chlorophyll and its derivatives, are found in green leafy vegetables, cereal grasses, marine plants and single-cell organisms such as spirulina and chlorella. Chelators bind with metal ions and other toxins to aid in detoxification of a subject. Dietary chlorophyll is not absorbed in the GI tract of humans and rats, but is instead metabolized and excreted in feces as pheophytin. Because of its complex forming ability, ingestion of chlorophyll results in increased excretion of environmental chemicals such as heterocyclic amines and dioxin.

Detoxification is a process of removing foreign chemicals from the body of humans and animals, such as mammals. Foreign chemicals can be products of the natural world (lead, for example), but most are man-made. There are now more than 10,000 chemicals being commercially produced and over one million have been synthesized at one time or another. Accumulated in the body tissues over a period of time, or as a result of acute exposure, these chemicals, also described as a chemical body burden, present a real threat to human and animal health ranging from acute poisoning to chronic toxicity including reproductive toxicity.

Human detoxification system includes (a) biotransformation and (b) excretion. Biotransformation mainly occurs in the liver, but to some extent also in the kidneys, skin or other organs and includes a large number of distinct enzymes that modify foreign chemicals and prepare them for excretion. Excretion includes transport of foreign chemicals out of the body through urine, bile and gastrointestinal tract. When foreign chemicals are excreted through the bile into the intestine, they can become subject to reabsorption into the bloodstream and subsequent enterohepatic recirculation. Enterohepatic recirculation diminishes intestinal excretion of foreign chemicals. Therefore, reducing the level of enterohepatic recirculation would positively influence the results of detoxification.

A need exists for improved detoxification compositions that can increase the removal of foreign chemicals from the body by selecting a) a natural chelator to enhance the binding of the toxins and b) combining it with fiber sources based on their ability to resist degradation by intestinal microbiota, thus reducing desorption and enterohepatic recirculation of the foreign chemicals in humans and animals.

### BRIEF SUMMARY OF THE INVENTION

The present invention relates to a dietary fiber composition comprising:

about 25% to about 75% fermentation-resistant dietary fiber;

about 25% to about 75% fermentable dietary fiber; and

about 1% to about 50% of a natural chelator.

In a preferred aspect, the invention relates to a dietary fiber composition comprising about 25% to about 70% fermentation-resistant dietary fiber; more preferably about 30% to about 70% fermentation-resistant dietary fiber; most preferably about 45% to about 70% fermentation-resistant dietary fiber.

In another aspect, the invention relates to a dietary fiber composition further comprising a physiologically acceptable carrier or a beverage base. In a preferred aspect, the invention relates to a dietary fiber composition further comprising a flavoring agent.

In still another aspect, the invention relates to a dietary fiber composition wherein the fermentation-resistant fiber is about 45% to about 80% of the total dietary fiber of the composition; more preferably about 50% to about 80% of the total dietary fiber of the composition; most preferably about 55% to about 80% of the total dietary fiber of the composition.

In yet another aspect, the invention relates to a dietary fiber composition comprising a fermentation-resistant dietary fiber which is a natural fiber product. In a preferred aspect, the natural fermentation-resistant fiber product is a natural fiber product comprising about 25% to about 75% of fermentation-resistant fiber; more preferably about 30% to about 75% of fermentation resistant fiber; most preferably about 35% to about 75% of fermentation resistant fiber. In a related aspect, the natural fiber fermentation-resistant product includes, but is not limited to, fiber derived from green peas, tomato, asparagus, banana, black-eyed peas, pear, green beans, lettuce, pinto beans, lentils, pineapple, apple, kale, spinach, sweet potato, flax seed, lima beans, kidney beans, beets, peach, cauliflower, cabbage, plum, squash, carrots, navy bean, garbanzo bean, potato, broccoli, Brussels sprouts, corn, white beans, orange, grapefruit or pea hulls; preferably fiber derived from green peas, flax seed, bamboo sprouts, rice bran, or pea hulls.

In another aspect, the invention relates to a dietary fiber composition comprising a natural chelator. In a preferred aspect, the natural chelator is chlorophyll, including but not limited to chlorophyll derived green plants and algae including, but not limited to, alfalfa grass, barley grass, wheat grass, spinach, cilantro, parsley, sage, kale, Spirulina or chorella. In a distinct embodiment of the invention, synthetic chelators may be employed in addition to or in place of the natural chelators described herein. Synthetic chelators include, but are not limited to, ethylenediaminetertraacetic acid (EDTA), 2,3-dimercaptopropane-1-sulfonate (DMPS), and meso-2,3-dimercaptosuccinic acid (DMSA).

In a distinct aspect, the present invention relates to a dietary fiber composition in the form of a powdered nutritional product. In a related embodiment, the powdered nutritional product can be mixed with water, fruit juice or vegetable juice prior to consumption. In another related embodiment, the dietary fiber composition is in the form of a liquid nutritional product, preferably a product which contains water, fruit juice or vegetable juice.

In a distinct embodiment, the invention relates to a composition comprising flax seed flour, pea hulls fiber, whole leaf young alfalfa, barley grass and chia seed; preferably about 67% flax seed flour, about 30% pea hulls fiber, about 2% whole leaf young alfalfa and barley grass combined and about 1% chia seed.

In another distinct embodiment, the invention relates to a composition comprising pinto bean fiber, tomato fiber, wheat grass and chia seed; preferably about 67% pinto bean fiber, about 30% tomato fiber, about 2% wheat grass and about 1% chia seed.

In another distinct embodiment, the invention relates to a composition comprising lentil fiber, asparagus fiber, cilantro and chia seed; preferably about 67% lentil, about 30% asparagus fiber, about 2% cilantro and about 1% chia seed.

In yet another distinct embodiment, the invention relates to a method of treating, preventing or managing a toxic condition in a subject in need thereof comprising administering to the subject a dietary fiber composition comprising about 25% to about 75% fermentation-resistant dietary fiber;

about 25% to about 75% fermentable dietary fiber; and

about 1% to about 50% of a natural chelator.

In a preferred embodiment, the subject is a mammal, preferably a human. In some embodiments, the human subject is a male or a female. In still other embodiments, the human subject is an elderly individual, an adult individual or an adolescent individual. In other embodiments, the human subject is suffering from one or more side effects of a toxic condition, including but not limited to, constipation, drowsiness, sluggishness, headache, muscle ache, muscle stiffness, increased incidence of wrinkles, dry skin, oily skin, cancer, high blood pressure, asthma, deficit in attention, deficit in memory, deficit in learning, deficit in IQ, shortened lactation, endometriosis, peripheral nerve damage, dysfunctional gastrointestinal systems and dysfunctional immune systems.

It is noted that in this disclosure and particularly in the claims and/or paragraphs, terms such as “comprises”, “comprised”, “comprising” and the like can have the meaning attributed to it in U.S. Patent law; e.g., they can mean “includes”, “included”, “including”, and the like; and that terms such as “consisting essentially of” and “consists essentially of” have the meaning ascribed to them in U.S. Patent law, e.g., they allow for elements not explicitly recited, but exclude elements that are found in the prior art or that affect a basic or novel characteristic of the invention.

These and other embodiments are disclosed or are obvious from and encompassed by, the following Detailed Description.

### DETAILED DESCRIPTION OF THE INVENTION

### Definitions

The following definitions can be referenced to assist in understanding the subject matter of the present application. Additional terms may be found defined throughout the detailed description.

As used herein, unless otherwise specified, the term “fermentation-resistant fiber” includes, but is not limited to, the portion of naturally occurring fibers which is able to withstand degradation due to fermentation. In particular, fermentation-resistant fibers are able to withstand degradation due to fermentation in the digestive system, such as by microbes in the small intestine (ileum) and colon (cecum) of a subject.

As used herein, unless otherwise specified, the term “natural chelator” includes, but is not limited to, chlorophyll and other derivatives found in green leafy vegetables, cereal grasses, marine plants and single-cell organisms such as spirulina and chlorella which bind with metal ions or other toxins and foreign chemicals.

As used herein, unless otherwise specified, the term “treating a toxic condition” or “treatment of toxicity” includes, but is not limited to, increasing the excretion of toxins or foreign chemicals, or enhancing the elimination of foreign chemicals from the system of a subject in need thereof.

As used herein, unless otherwise specified, the term “managing a toxic condition” includes, but is not limited reducing the amount of toxin present in the system of a subject or preventing the increase of toxin buildup in the system of said subject.

As used herein, unless otherwise specified, the term “preventing,” includes, but is not limited to, inhibition or the averting of symptoms associated with a particular disease or disorder.

As used herein, unless otherwise specified, the term “physiologically acceptable carrier,” includes, but is not limited to, a carrier medium that does not interfere with the effectiveness of the biological activity of any active ingredients, is chemically inert, and is not toxic to the consumer or patient to whom it is administered.

Fermentation-Resistant Fibers

The various embodiments of the invention utilize natural dietary fibers in the dietary fiber compositions of the invention. Natural fibers are made up of fermentation-resistant fibers and fermentable fibers. While some naturally occurring fiber sources contain only fermentable components, no naturally occurring fibers comprise only fermentation resistant fibers. A number of naturally occurring fibers which may be utilized in the present invention include, but are not limited to, those described below in Table 1.

TABLE 1
Classification of Fiber components based on fermentability.

| Characteristic | Fiber Component | Main Food Source |
|---|---|---|
| Partial or low fermentation | Cellulose | Plants (vegetables, sugar beet, |
| | | various brans) |
| | Hemicellulose | Cereal grains |
| | Lignin | Woody plants |
| | Cutin/suberin/other plant waxes | Plant fibers |
| | Chitin and chitosan, collagen | Fungi, yeasts, invertebrates |
| | Resistant starches | Plants (corn, potatoes, grains, |
| | | legumes, bananas) |
| | Curdlan | Bacterial fermentation |
| Well fermented | β-glucans | Grains (oat, barley, rye) |
| | Pectins | Fruits, vegetables, legumes, |
| | | sugar beet, potato |
| | Gums | Leguminous seed plants (guar, |
| | | locust bean), seaweed extracts |
| | | (carrageenan, alginates), plant |
| | | extracts (gum acacia, gum |
| | | karaya, gum tragacanth), |
| | | microbial gums (xanthan, gellan) |
| | Inulin | Chicory, Jerusalem artichoke, |
| | | onions, wheat |
| | Oligosaccharides/analogues | Various plants (polydextrose, |
| | | resistant maltodextrin, |
| | | fructooligosaccharides, |
| | | galactooligosaccharides, |
| | | lactulose) |
| | Animal origin | Chondroitin |

Fermentability is represented by the systemic degradation of fibers (or fiber systems) by intestinal microbiota through the process of fermentation. Based on their fermentability, dietary fibers can be classified into two groups: (a) fermentable and (b) fermentation-resistant fibers. Fermentability of dietary fibers depends on their chemical structure and composition. Fermented fiber components include, but are not limited to, beta-glucans, pectins, gums, inulin and various oligosaccharides. Fiber components resistant to fermentation include, but are not limited to, cellulose, hemicellulose, lignin, plant waxes (cutin, suberin), chitin and chitosan.

In order to increase the efficacy and percentage of fermentation-resistant fibers in the dietary fiber compositions of the invention, the composition of cellulose and lingin can be determined in order to determine the fermentation-resistant component ratio. Representative ratios are described below in table 2.

TABLE 2
Cellulose and lignin content of fibers
from 34 fruits and vegetables.

| | Cellulose % | Lignin % | (Cellulose + lignin) % |
|---|---|---|---|
| | of fiber | of fiber | of fiber |
| Green peas | 60.0% | 4.2% | 64.2% |
| Tomato | 50.1% | 12.9% | 63.0% |
| Asparagus | 45.1% | 15.1% | 60.2% |
| Banana | 14.0% | 43.8% | 57.8% |
| Black-eyed peas | 36.2% | 19.8% | 56.0% |
| Pear | 36.9% | 15.4% | 52.2% |
| Green beans | 44.1% | 7.5% | 51.6% |
| Lettuce | 41.2% | 9.6% | 50.8% |
| Pinto beans | 32.9% | 17.1% | 50.0% |
| Lentils | 32.7% | 16.5% | 49.2% |
| Pineapple | 44.1% | 2.2% | 46.3% |
| Apple | 28.0% | 17.5% | 45.6% |
| Kale | 35.2% | 10.0% | 45.3% |
| Spinach | 30.8% | 14.3% | 45.1% |
| Sweet potato | 41.0% | 3.8% | 44.8% |
| Lima beans | 38.1% | 5.6% | 43.8% |
| Kidney beans | 25.9% | 16.1% | 42.1% |
| Beets | 38.0% | 2.5% | 40.5% |
| Peach | 30.5% | 9.3% | 39.8% |
| Cauliflower | 37.3% | 2.4% | 39.7% |
| Cabbage | 35.9% | 3.6% | 39.5% |
| Plum | 25.5% | 13.6% | 39.1% |
| Squash | 28.6% | 9.7% | 38.3% |
| Carrots | 32.9% | 4.3% | 37.1% |
| White beans | 29.9% | 6.8% | 36.8% |
| Navy bean | 30.2% | 5.3% | 35.5% |
| Garbanzo beans | 25.1% | 10.3% | 35.4% |
| Potato, white | 24.6% | 9.5% | 34.1% |
| Broccoli | 29.2% | 4.8% | 34.0% |
| Brussels sprouts | 30.8% | 2.3% | 33.1% |
| Corn | 25.9% | 5.8% | 31.7% |
| White beans | 22.6% | 5.7% | 28.3% |
| Orange | 21.6% | 2.7% | 24.3% |
| Grapefruit | 18.9% | 3.6% | 22.5% |

Without being limited by theory, it is believed that the compositions of the invention utilize low fermentation potential fibers and a natural chelator in a specific ratio to optimize removal of foreign chemicals and toxins via the mammalian colon. The specific ratio of fibers at the range suggested yields several times the effectiveness of the more commonly used fibers in removing toxins and foreign chemicals from the body because of the unique characteristics of these fermentation-resistant fibers. The select fibers can result in: preservation of sorbing properties of fiber while in the GI tract; reduction of fiber desorption as a result of fermentation by intestinal microbiota; prevention of reabsorption of foreign chemicals from the intestine into the bloodstream; reduction of enterohepatic recirculation of foreign chemicals; and more effective fecal elimination of foreign chemicals.

Natural Chelators

Natural chelators, such as chlorophyll and its derivatives, are found in green leafy vegetables, cereal grasses, marine plants and single-cell organisms such as spirulina and chlorella. Chelators bind with metal ions and other toxins to aid in detoxification of a subject. Dietary chlorophyll is not absorbed in the GI tract of humans and rats but metabolized and excreted in feces as pheophytin. Because of its complex forming ability, ingestion of chlorophyll results in increased of excretion of environmental chemicals such as heterocyclic amines and dioxin.

Modes of Administration

The magnitude of the therapeutic dose of the fermentation-resistant fiber and natural chelator composition in the treatment, prevention or management of a toxic condition in a subject will vary with the severity of the toxicity and the route of administration. The dose, and perhaps the dose frequency, will also vary according to age, body weight, response, and the past medical history of the consumer or subject. Suitable dosing regimens can be readily selected by those skilled in the art with due consideration of such factors.

Fermentation-resistant fiber and natural chelator compositions can be formulated using standard formulation techniques into powders, pastes, pastilles, slurries, etc. See, e.g., Remington's Pharmaceutical Sciences, 18th ed., Mack Publishing, Easton Pa. (1990). Fermentation-resistant fiber and natural chelator compositions of the invention may be formulated into a dietary supplement or a pharmaceutical preparation for the administration to mammals for the treatment, prevention or management of a toxic condition. In a preferred embodiment, the mammal is human. In still more preferred embodiments, the human is an elderly individual, an adult individual or an adolescent individual.

Compositions comprising fermentation-resistant fiber and natural chelator compositions of the invention formulated in a compatible pharmaceutical carrier may be prepared, packaged, and labeled for treatment, prevention, or management of a toxic condition or symptoms or side effects thereof.

The compositions of the invention may include food compositions, beverage compositions, and dietary supplements. The fermentation-resistant fiber and natural chelator compositions may be added to various foods so as to be consumed simultaneously. As a food additive, the fermentation-resistant fiber and natural chelator compositions of the invention may be used in the same manner as conventional food additives, and thus, only needs to be mixed with other components to enhance the taste. Taste enhancement includes, but is not limited to, imparting to food a refreshingness, vitality, cleanness, fineness, or bracingness to the inherent taste of the food.

For oral administration, the composition may be in liquid form, for example, solutions, syrups or suspensions, or may be presented as a powdered food product for reconstitution with water or other suitable vehicle before use, including but not limited to, electrolyte enriched beverages, fruit juice or vegetable juice. Such liquid preparations may be prepared by conventional means such as a tea, health beverage, dietary shake, liquid concentrate, or liquid soluble tablet, capsule, pill, or powder such that the beverage may be prepared by dissolving the liquid soluble tablet, capsule, pill, or powder within a liquid and consuming the resulting beverage. Such liquid preparations may also be prepared by conventional means with physiologically acceptable additives such as suspending agents (e.g., sorbitol syrup, cellulose derivatives or hydrogenated edible fats); emulsifying agents (e.g., lecithin or acacia); non-aqueous vehicles (e.g., almond oil, oily esters, or fractionated vegetable oils); and preservatives (e.g., methyl or propyl-p-hydroxybenzoates or sorbic acid).

The compositions may take the form of, for example, tablets, chewable tablets or capsules prepared by conventional means with pharmaceutically acceptable excipients such as binding agents (e.g., pregelatinized maize starch, polyvinyl pyrrolidone or hydroxypropyl methylcellulose); fillers (e.g., lactose, microcrystalline cellulose or calcium hydrogen phosphate); lubricants (e.g., magnesium stearate, talc or silica); disintegrants (e.g., potato starch or sodium starch glycolate); or wetting agents (e.g., sodium lauryl sulphate). The tablets may be coated by methods well-known in the art. Preparations for oral administration may be suitably formulated to give controlled release of the active compound. Alternatively, the dietary supplements may optionally include other dietary supplements including vitamins, minerals, other herbal supplements, binding agents, fillers, lubricants, disintegrants, or wetting agents, as those discussed above. In a preferred embodiment, the dietary supplement may take the form of a capsule or powder to be dissolved in a liquid for oral consumption.

The compositions may, if desired, be presented in a pack or dispenser device which may comprise one or more unit dosage forms comprising the active ingredients. The pack may for example comprise metal or plastic foil, such as a pouch. The pack or dispenser device may be accompanied by instructions for administration.

The amount of fermentation-resistant fiber and natural chelator compositions in a beverage or incorporated into a food product will depend on the kind of beverage, food and the desired effect.

Examples of food include, but are not limited to, confectionery such as sweets (candies, jellies, jams, etc.), gums, bean pastes, baked confectioneries or molded confectioneries (cookies, biscuits, etc.), steamed confectioneries, cacao or cacao products (chocolates and cocoa), frozen confectioneries (ice cream, ices, etc.), beverages (fruit juice, soft drinks, carbonated beverages), health drinks, health bars, and tea (green tea, black tea, etc.).

In certain embodiments, a composition of the invention can be administered with or other medications, herbs or foods that increase biotransformation of foreign chemicals liver and bile stimulants, laxatives or any other measures that are used for detoxification. These include but are not limited to senna leaf, rhubarb root, cascara sagrada bark, ginger root, licorice root, irish moss, butternut, Magnolia bark, Dandelion root, Tangerine peel, Ho Shou Wu (fo ti) root, bush cherry pit, garlic, buckthorn tree bark, catnip herb, celery seed, cilantro, Chamomile, chickweed herb, comfrey leaf, cranberry, damania leaf, Devil's Claw root, and cayenne.

Dosage

The magnitude of a therapeutic or prophylactic dose of Fermentation-resistant fiber and natural chelator compositions in the prevention, treatment, or management of a toxic condition will vary with the severity of the condition of the consumer or patient to be treated and the route of administration. The dose, and dose frequency, will also vary according to the age, body weight, condition and response of the individual consumer or patient, and the particular Fermentation-resistant fiber and natural chelator composition used. All combinations described in the specification are encompassed as therapeutic, and it is understood that one of skill in the art would be able to determine a proper dosage of particular Fermentation-resistant fiber and natural chelator composition using the parameters provided in the invention.

In general, the total daily dose ranges of the Fermentation-resistant fiber and natural chelator composition for the conditions described herein are generally from about 70 mg/kg to about 500 mg/kg administered in divided doses administered orally. A preferred total daily dose is from about 100 mg/kg to about 145 mg/kg of the Fermentation-resistant fiber and natural chelator composition.

Alternatively, the daily dose of the fermentation-resistant fiber and natural chelator composition for the conditions described herein are generally from about 5000 mg to about 35000 mg, preferably from about 7500 mg to 10000 mg.

For example, in one embodiment, the daily dose ranges of fermentation-resistant fiber and natural chelator compositions described herein are generally about 140 mg per kg body weight. Preferably the fermentation-resistant fiber and natural chelator composition of the invention is given daily, under supervision, for a ten day cycle, followed by one to ten additional cycles, each lasting about ten days in duration. As the fermentation-resistant fiber and natural chelator composition are safe for daily use, the formulation may be administered for as long as necessary to achieve the desired therapeutic effect.

The dietary supplements and fiber compositions of the present invention comprise fermentation-resistant fiber and natural chelator composition, as well as pharmaceutically acceptable salts thereof, and may also comprise a pharmaceutically acceptable carrier, and optionally, other therapeutic ingredients.

The invention will now be further described by way of the following non-limiting examples.

### EXAMPLES

### Example 1

### Formulation of Fermentation-Resistant Fibers and a Natural Chelator

| | | | | Fermentation- | |
|---|---|---|---|---|---|
| | Mg per | Total dietary | TDF, mg per | resistant fiber | FRF, mg |
| | serving | fiber (TDF), % | serving | (FRF) % of TDF, est. | per serving |
| Flax Seed Flour | 6,700 | 31.3 | 2097.1 | 50 | 1048.55 |
| Pea Hulls Fiber | 3,000 | 89.3 | 2679 | 64 | 1714.56 |
| Whole Leaf young | 200 | 12 | 24 | 20 | 4.8 |
| Alfalfa/Barley grass | | | | | |
| Chia Seed | 100 | 50 | 50 | 20 | 10 |
| Total | 10,000 | | 4,850 | | 2,778 |

Fermentation resistant fiber content of the composition 27.8%
Fermentation resistant fiber content of TDF 57.3%
Natural chelator(chlorophyll containing dehydrated cereal grass powder) - 2% of the composition

### Example 2

### Formulation of Fermentation-Resistant Fibers and a Natural Chelator

| | | | | Fermentation- | |
|---|---|---|---|---|---|
| | Mg per | Total dietary | TDF, mg per | resistant fiber | FRF, mg |
| | serving | fiber (TDF), % | serving | (FRF) % of TDF, est. | per serving |
| Pinto Bean | 6,700 | 31.3 | 2097.1 | 50 | 1048.55 |
| Fiber | | | | | |
| Tomato Fiber | 3,000 | 89.3 | 2679 | 63 | 1687.77 |
| Wheat Grass | 200 | 12 | 24 | 20 | 4.8 |
| Chia Seed | 100 | 50 | 50 | 20 | 10 |
| Total | 10,000 | | 4,850 | | 2,751.12 |

Fermentation-resistant fiber content of the composition - 27.1%
Fermentation-resistant fiber content of TDF - 56.7%
Natural chelator(chlorophyll-containing dehydrated wheat grass powder) - 2% of the composition

### Example 3

### Formulation of Fermentation-Resistant Fibers and a Natural Chelator

| | | | | Fermentation- | |
|---|---|---|---|---|---|
| | Mg per | Total dietary | TDF, mg | resistant fiber | FRF, mg |
| | serving | fiber (TDF), % | per serving | (FRF) % of TDF, est. | per serving |
| Lentil fiber | 6,700 | 31.3 | 2097.1 | 49 | 1027.55 |
| Asparagus Fiber | 3,000 | 89.3 | 2679 | 60 | 1607.4 |
| Cilantro | 200 | 12 | 24 | 20 | 4.8 |
| Chia Seed | 100 | 50 | 50 | 20 | 10 |
| Total | 10,000 | | 4,850 | | 2,634.95 |

Fermentation-resistant fiber content of the composition - 26.3%
Fermentation-resistant fiber content of TDF - 54.3%
Natural chelator(chlorophyll-containing dehydrated ciiantro powder) - 2% of the composition

Preparation of Formulations 1-3:

In Examples 1-3 above, the fiber and natural chelator powders are placed into a blend tank at room temperature and mixed by paddle mixing. One of skill in the art will recognize that shaking, stirring, ball milling, ribbon mixing or any other means of agitation known to those of skill in the art may be utilized when mixing the formulation powders. The powders can be commercially purchased or produced by any means known to those of skill in the art.

After mixing, the combined formulation powder is packaged in single serving pouches or any other suitable containers.

### Example 4

### Determination of Effectiveness of Detoxification

Fecal excretion of heavy metals and PCBs is tested in human volunteers utilizing the present invention. A diet standardized by the amount of heavy metals and PCBs, are provided to human volunteers. The levels of fecal excretion of heavy metals and PCBs are obtained using a high sensitivity quantitative detection method for heavy metals and PCBs suitable for their detection in the fecal matter. An acceptable detection method would be as described by Rohde et al., Chemosphere. 1999, 38(14): 3397-3410 (Clearance of PCDD/Fs via the gastrointestinal tract in occupationally exposed persons), though one of skill in the art could also use any detection method generally accepted in the field. First week measurements are used as a control. After one week, human volunteers are provided a daily serving of a dietary fiber composition of the invention. Levels of fecal excretion are determined again using the same methods and results are compared to the control.

Having thus described in detail preferred embodiments of the present invention, it is to be understood that the invention defined by the above paragraphs is not to be limited to particular details set forth in the above description as many apparent variations thereof are possible without departing from the spirit or scope of the present invention.

### REFERENCES

(1) National Academy of Sciences. Dietary, Functional and Total Fiber. Dietary reference intakes for Energy, Carbohydrate, Fiber, Fat, Fatty Acids, Cholesterol, Protein, and Amino Acids (Macronutrients). National Academy of Sciences; 2005:265-334.
(2) Aozasa O, Ohta S, Nakao T, Miyata H, Nomura T. Enhancement in fecal excretion of dioxin isomer in mice by several dietary fibers. Chemosphere. 2001; 45: 195-200.
(3) Tungland B C, Meyer D. Nondigestible oligo- and polysaccharides (dietary fiber): their physiology and role in human health and food. Comprehensive Reviews in Food Science and Food Safety. 2002; 1:73-77.
(4) Widmaier F, Raff H, Strang K. Human Physiology—The Mechanisms of Body Function. Ninth ed. New York: McGraw-Hill; 2005.
(5) McBurney M I, Thompson L U. Effect of human faecal donor on in vitro fermentation variables. Scand J Gastroenterol. 1989; 24:359-367.
(6) Morita K, Ogata M, Hasegawa T. Chlorophyll derived from Chlorella inhibits dioxin absorption from the gastrointestinal tract and accelerates dioxin excretion in rats. Environ Health Perspect. 2001; 109:289-294.
(7) Egner P A, Wang J B, Zhu Y R et al. Chlorophyllin intervention reduces aflatoxin-DNA adducts in individuals at high risk for liver cancer. Proc Natl Acad Sci USA. 2001; 98:14601-6.
(8) Rohde et al., Clearance of PCDD/Fs via the gastrointestinal tract in occupationally exposed persons. Chemosphere. 1999, 38(14): 3397-3410

What is claimed as new and desired to be protected by Letters Patent of the United States is:

1. A dietary fiber composition comprising:
a. about 25% to about 75% fermentation-resistant dietary fiber;
b. about 25% to about 75% fermentable dietary fiber; and
c. about 1% to about 50% of a natural chelator.

2. The dietary fiber composition of claim 1, further comprising a physiologically acceptable carrier or a beverage base.

3. The dietary fiber composition of claim 2, further comprising a flavoring agent.

4. The dietary fiber composition of claim 1, wherein the fermentation-resistant dietary fiber is about 45% to about 80% of the total dietary fiber of the composition.

5. The dietary fiber composition of claim 4, wherein the fermentation-resistant dietary fiber is about 50% to about 80% of the total dietary fiber of the composition.

6. The dietary fiber composition of claim 5, wherein the fermentation-resistant dietary fiber is about 55% to about 80% of the total dietary fiber of the composition.

7. The dietary fiber composition of claim 1, wherein the fermentation-resistant dietary fiber is a natural fiber product.

8. The dietary fiber composition of claim 7, wherein the natural fiber product is fiber derived from green peas, tomato, asparagus, banana, black-eyed peas, pear, green beans, lettuce, pinto beans, lentils, pineapple, apple, kale, spinach, sweet potato, flax seed, lima beans, kidney beans, beets, peach, cauliflower, cabbage, plum, squash, carrots, navy bean, garbanzo bean, potato, broccoli, Brussels sprouts, corn, white beans, orange, grapefruit or pea hulls;

9. The dietary fiber composition of claim 8, wherein the natural fiber product is derived from green peas, flax seed, or pea hulls.

10. The dietary fiber composition of claim 1, wherein the natural chelator is chlorophyll derived from alfalfa grass, barley grass, wheat grass, spinach, cilantro, parsley, sage, or kale.

11. The dietary fiber composition of claim 1, wherein the composition is in the form of a powdered nutritional product.

12. The dietary fiber composition of claim 1, wherein the composition is in the form of a liquid nutritional product.

13. The dietary fiber composition of claim 12, wherein the liquid nutritional product comprises water, fruit juice or vegetable juice.

14. A dietary fiber composition comprising flax seed flour, pea hulls fiber, whole leaf young alfalfa, barley grass and chia seed.

15. The dietary fiber composition of claim 14 comprising about 67% flax seed flour, about 30% pea hulls fiber, about 2% whole leaf young alfalfa and barley grass combined and about 1% chia seed.

16. A method of treating, preventing or managing a toxic condition in a subject in need thereof comprising administering to the subject a dietary fiber composition comprising:
a. about 25% to about 75% fermentation-resistant dietary fiber;
b. about 25% to about 75% fermentable dietary fiber; and
c. about 1% to about 50% of a natural chelator.

17. The method of claim 16 wherein the subject is a mammal.

18. The method of claim 17 wherein the mammal is a human.

19. The method of claim 18 wherein the human is suffering from one or more side effects of a toxic condition.
